(19) United States
(12) Patent Application Publication
(10) Pub. No.: US 2012/0209896 A1
(43) Pub. Date: Aug. 16, 2012

(54) System and Method for Storing Files of Multiple Users

(76) Inventor: Adam Marc Raymond, Scarsdale, NY (US)

(21) Appl. No.: 13/024,774

(22) Filed: Feb. 10, 2011

(51) Int. Cl. G06F 17/30

(52) U.S. Cl. 707/827; 707/E17.01

(57) ABSTRACT

A system and method for file sharing comprises receiving at a server tags corresponding to files of a user. The tags are based on information from the files and are associated with the user. Each of the tags is stored in a list associated with the user and compared to a list of tags previously stored by the server. The list of tags previously stored by the server includes tags associated with a plurality of different users and having corresponding files stored by the server. The server receives a file of the files which correspond to the tags in the list associated with the user if a corresponding tag of the file is not in the list of tags previously stored by the server. The user is provided access to files stored by the server which correspond to the tags stored in the list associated with the user.

### FIELD OF THE INVENTION

The present invention relates to file sharing and in particular to a system and method for storing, sharing and providing access to digital media.

### DESCRIPTION OF THE RELATED ART

Users typically have multiple digital devices that are capable of playing back media files containing music and/or video data. An individual user may have a personal computer, a smart-phone and a tablet device, each of which is capable of playing back media files. However, the user may have his/her media collection stored on only one of these devices, or have some media files stored on one device and other media files stored on other devices. Transferring the media collection to another device is often a time-intensive operation because data transfer rates between the devices are limited and media collections are often large in size. Moreover, one or more of the other devices may not have sufficient memory to store the entire media collection of the user.

Web-based applications have been developed that allow users to send their music collections to other devices over the Internet. One such web-based application, Music Sync, enables users to move music from their computers to their mobile devices using an over-the-air (OTA) data connection. Music Sync lets users synchronize their music on an on-demand basis, while they listen to their music. Music Sync users can navigate their entire PC-based music library from their mobile devices. When a user chooses to play a song that is not yet on the mobile device (e.g. MP3 player, etc.), Music Sync plays the song while simultaneously transferring the song to the mobile device. Music Sync uploads music from the user's computer to the user's mobile device and does store the music on an intermediary server. Moreover, Music Sync does not provide any type of redundancy checking of files between different users because only the single user is able to access his/her PC-based music library.

Other web-based applications allow users to upload their media collections from a first device to a web server that allows the users to access the uploaded content from a second device. However, these servers require each user to upload each of his or her files from the first device to the server in order to access the files from the second device. Accordingly, data transfer remains a time-intensive operation because each of the files must be uploaded to the server due to the lack of any type of redundancy checking of files between users.

### SUMMARY OF THE INVENTION

According to an example embodiment of the invention, a method is described for storing and providing access to digital content by receiving at a server one or more tags corresponding to one or more files of a user. The tags are based on information from the files, and each of the tags is associated with the user. Each of the tags is stored in a list associated with the user. Each of the tags stored in the list associated with the user is compared to a list of tags previously stored by the server. The list of tags previously stored by the server includes tags associated with a plurality of different users having files corresponding to the different users which are stored by the server. A file of the one or more files which correspond to the tags in the list associated with the user is received and stored at the server if a corresponding tag of the file is not already in the list of tags previously stored by the server. The user is provided access to each of the files stored by the server in the server or a database which correspond to the tags stored in the list associated with the user.

According to another example embodiment of the invention, a system is described for storing and providing access to stored digital content between a user device and a server. The user device is configured to create one or more identifiers, such as tags corresponding to one or more files of a user based on information from the files. Each of the tags is associated with the user. The server is configured to receive each of the tags from the user device, store each of the tags in a list associated with the user, compare each of the tags stored in the list associated with the user to a list of tags previously stored by the server, the list of tags previously stored by the server including tags associated with a plurality of different users having files corresponding to the different users which are stored by the server, receive a file of the one or more files which correspond to the tags in the list associated with the user from the user device if a corresponding tag of the file is not in the list of tags previously stored by the server; cause the storing of each of the files sent from the user device, and provide the user access to each of the files stored by the server which correspond to the tags stored in the list associated with the user.

According to still another example embodiment of the invention, a non-transitory computer readable medium storing a computer program which when executed by a computer performs a method that comprises receiving at a server one or more tags corresponding to one or more files of a user. The tags are based on information from the files, and each of the tags is associated with the user. Each of the tags is stored in a list associated with the user by the server. Each of the tags stored in the list associated with the user is compared to a list of tags previously stored by the server. The list of tags previously stored by the server includes tags associated with a plurality of different users having fifes corresponding to the different users which are stored by the server. A file of the one or more files which correspond to the tags in the list associated with the user is received and stored by the server if a corresponding tag of the file is not in the list of tags previously stored by the server. The user is provided access to each of the files stored by the server which correspond to the tags stored in the list associated with the user.

### BRIEF DESCRIPTION OF THE DRAWINGS

The invention will now be described in further detail with reference to the drawings in which:

FIG. 1 is a block diagram of a file-sharing system according to an example embodiment; and

FIG. 2 is a flow chart showing a process according to an example embodiment.

### DETAILED DESCRIPTION OF THE PRESENTLY PREFERRED EMBODIMENTS

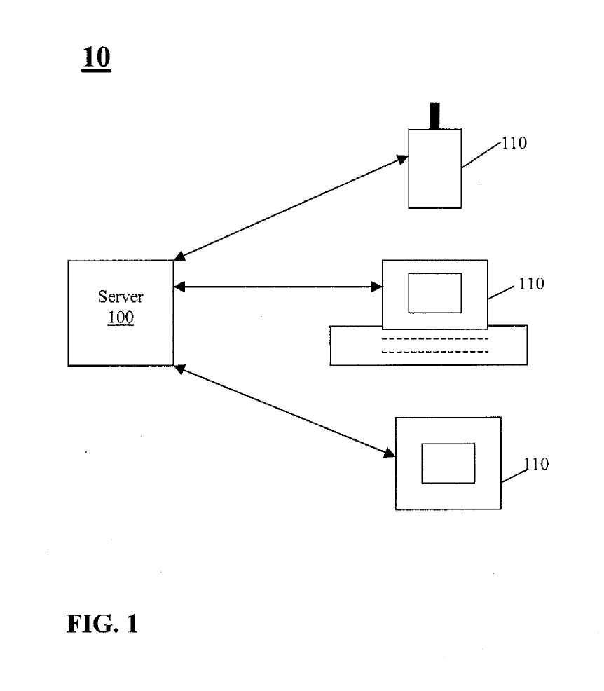

FIG. 1 is a block diagram of a file-sharing system 10 according to an example embodiment. The file-sharing system 10 comprises a server 100 and one or more user devices 110.

The server 100 comprises a processor, RAM and/or ROM memory and a communications interface for communicating with other devices over the Internet, an intranet or another wired or wireless communication interface. The server 100 may be in communication with a database or, alternatively, the database may be included in the server 100. The database is configured to store digital files including audio, video, text and other digital media content or content related thereto. The server 100 includes or communicates with one or more modules or units for controlling and managing the server 100, a user's access to the server 100 and the digital media content of the database, namely a server application.

The one or more user devices 110 may be personal computers, cellular telephones, tablet computers, portable digital content (e.g., music) players or other devices that include a processor, RAM and/or ROM memory and a communications interface for communicating with other devices over the Internet, an intranet or another wired or wireless communication interface. The one or more user devices 110 comprise a web browser configured to access and communicate with the server 100 via the Internet and/or a module or unit comprising a local application program configured to access the server 100 and interact with the server application. Each user device 110 may be used by a plurality of different users to access the server 100.

The local application on the user device 110 includes a media player configured to play the media files in audio/visual form. Alternatively, the server application may provide a media player that is accessible to the user through the use of the web browser or the local application on the user device 110, e.g., as a Java applet, etc. The user device 110 comprises reproduction equipment such as speakers, a headphones output and/or a display configured to reproduce the played back media files in some form that is perceptible to human beings, e.g., as an audio and/or video performance.

The one or more user devices 110 may access and communicate with the server 100 via the Internet, an intranet or another wired or wireless communication interface. The web browser or the local application program is executed in the user device 110 to begin and establish communication with the server 100. If the web browser is used to access the server 100 and/or the server application located thereon, the user enters or selects a URL address into the web browser or accesses a link in the web browser to access the server 100. Alternatively, the local application program may automatically access the server 100 upon execution or when access is required for operation.

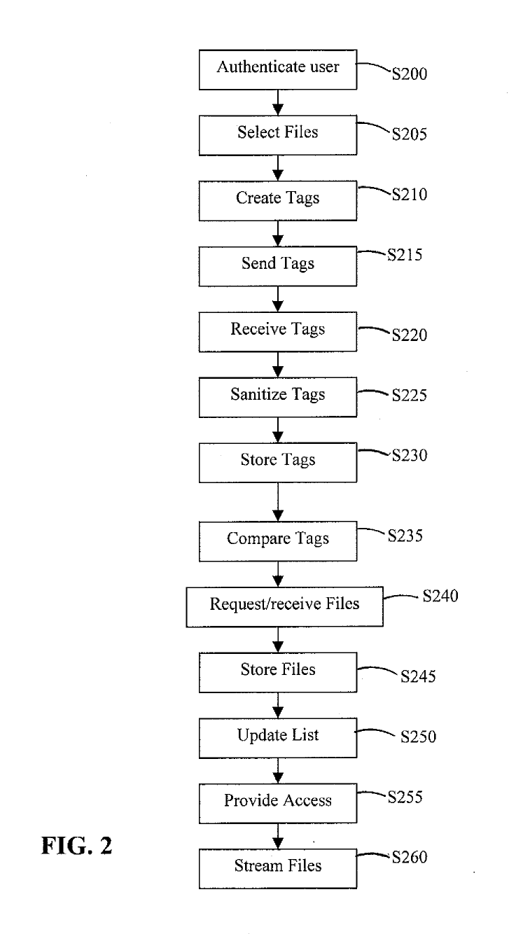

FIG. 2 is a flow chart showing a process according to an example embodiment. The user performs an authentication process with the server 100 to verify the identity of the user at the server 100 (S200). For example, the user is required to enter a username and password into the web browser or the local application program, and the web browser or the local application program sends the username and password to the server 100 for verification by the server application. The server 100 compares the username and password sent by the web browser or local application program from the user device 110 to user records stored by the server on the server or on another device in communication with the server and, if a match is found, grants the user access to the server application. The user may thus login to his or her account from any number of different user devices 110, and any number of different users may login into their respective accounts from the same user device 110.

The local application on the user device 110 and the server application are configured to communicate with each other to allow the user to access, upload to and/or download from, the server 100 digital media files and corresponding content such as playlists, user history and account information. The server application need not have direct local access to the user device 110 for file transfer between the user device 110 and the server 100. An embedded applet, e.g., a Java applet, running in the web browser or the local application provides the server application local access to files stored on the user device 110. In another example embodiment, the server application may provide the server 100 with direct local access to the user device 110 to search the user device 110 for files and to create tags for files as will be described in more detail below, and to allow the user to access, upload to and/or download from, the server 100 digital media files and corresponding content such as playlists, user history and account information.

The user may manually select digital media files located on the user device 110 or a peripheral device, such as a USB drive or external hard drive, of the user device 110 to add to the user's account on the server 100 through a graphical user interface (GUI) provided by the embedded applet or the local application (S205 in FIG. 2). For example, the user may select individual files and/or folders containing a plurality of files from various storage locations in the user device 110 to add to the server 100. Alternatively, the embedded applet or the local application may automatically scan the user device 110 and any peripheral device thereof for digital media to add to the user's account on the server 100. The automatic scanning operation performed by the embedded applet or the local application in the user device 110 is configured to scan for and select only the digital media files having file types or identifying information indicated by the user in the configuration.

After the digital media files are detected and selected, such as by the embedded applet or the local application, the embedded applet or the local application creates a media tag or fingerprint for each individual file of the selected digital media files (S210). A media tag may comprise any identifying information gathered by the embedded applet or the local application from a digital media file or entered by the user. For example, the media tag may comprise the artist, title and/or other information corresponding to an MP3 file, such as, an 1D3 tag of the MP3 that is lifted from the file or created by the embedded applet or the local application from information gathered from the file or metadata of the file. The media tag may comprise a sample of the digital media data stored in the file or a unique numeric signature of the digital media data stored in the file. For example, as is known in the art, the embedded applet or local application can create a spectrogram for each file, i.e., a graph that plots three dimensions of music and/or video: frequency vs. amplitude vs. time. The embedded applet or local application selects the points in the spectrogram that represent the peaks of the graph, i.e., portions that contain “higher energy content” than surrounding portions, and stores the peak values as the fingerprint or media tag of the file. The embedded applet or local application may store the local fife path of the file on the user device 110 in the media tag of the file. The embedded applet, the local application and/or the server application use the file path to verify that the file exists on the user device 110 before the file is requested and received by the server 100.

The embedded applet or the local application sends the media tags or fingerprints to the server 100 (S215). For example, the embedded applet sends the media tags to a Java script function which then forwards the media tags to a PHP Hypertext Pre-processor in the server 100. The media tags may be stored by the PHP Hypertext Pre-processor in the server 100 as a serialized array in a text file to create a main playlist for the user. However, example embodiments are not limited thereto and the media tags or fingerprints may be uploaded to and received by the server 100 (S220) from the user device 110 in any known manner that allows the server 100 to access and modify the media tags and create the main playlist for the user from the uploaded media tags.

The server application in the server 100 sanitizes the media tags or fingerprints before storing the media tags (S225). The server application modifies each media tag, if needed, so that each media tag is in the same format. For example, if the media tags include an artist identifier and a track identifier, the server application modifies the artist and track identifiers of each media tag to have a standard format. The sanitizing operation performed by the server application in the server 100 may remove spaces from the text of identifiers, change more obscure symbols in the text to more standard text, modify the artist and track identifiers such that similar artist and track identifiers have a standard spelling, and/or standardize the formatting of the media tags in various other manners such that each of the media tags uploaded by the different users have the same standardized format. If the media tags comprise spectrogram peaks, the media tags may be sanitized to have an identical number of peaks and/or peaks selected from the same portions or time periods of each digital media file. The media tags may comprise digital rights management (DRM) information or some other information that ensures that the user has access to the media file associated with the tag. The tags are stored in the database associated or in communication with the server 100 in association with the uploading user (S230), i.e., in the main playlist of the user.

The main playlist of each user includes a list of all of the media tags that have been uploaded by the user to the server 100. The main playlist created for each user is linked to or associated with the user's account in the server 100, and each of the tags in the main playlist is linked to the user's account in the server 100. The server 100 stores a list of all registered users and the associated account information for each of the registered users. The server 100 stores and maintains a master playlist including all of the media tags stored by the server 100 in the server 100 or the database in association with the different users that are linked to each of the media tags, and the files and the local file paths on the server 100 or in the database of the files corresponding to each of the media tags. The user may create any number of subsidiary playlists including a portion of the media tags included in the user's main playlist.

More recently uploaded media tags are stored in an upload list. The server application in the server 100 compares each of the media tags or fingerprints uploaded from the user device 110, i.e., the media tags in the upload list, to a database of all previously uploaded media tags, i.e., to the master playlist including all of the media tags stored by the server 100 in the server 100 and/or in the database (S235). If a media tag is not included in the master playlist, the media tag is added to a list of media tags for which the corresponding media file is to be uploaded from the user device 110 and removed from the upload list. If a media tag is already included in the master playlist, the media tag is not added to the list of media tags for which the corresponding media file is to be uploaded from the user device 110 and removed from the upload list, and the server application skips to the next media tag uploaded from the user device 110 in the upload list. For example, the server application may compare the artist and title identifiers of the media tags to the artist and title identifiers of the media tags stored in the master playlist, and add to the list of media tags for which the corresponding media file is to be uploaded from the user device 110 only those tags which do not match any of the tags in the master playlist. In another example embodiment, the server application may compare the unique numeric signature of the media data stored in the file on the user device 110 to the numeric signatures of each of the song tags stored in the mater playlist to determine the list of media tags for which the corresponding media data is to be uploaded from the user device 110.

The server application in the server 100 begins to request and upload the corresponding media data and files from the user device 110 that are associated with the media tags included in the list of media tags for which the corresponding media data is to be uploaded while the server application continues to compare the remaining media tags in the upload list to the media tags in the master playlist such that both processes may be running concurrently with each other (S240). The media files are stored by the server 100 in the server 100 and/or the database by the server application in association with their corresponding media tags (S245). The server 100 updates the list of tags previously stored by the server to include the corresponding tag of each of the files received at the server (S250). Accordingly, only those files for which a corresponding media tag does not yet exist in the server 100 or the database are uploaded to the server 100, and a transmission time required for uploading the user's media files is reduced by avoiding the uploading of redundant files.

The server 100 provides the user access to any media file for which there is a corresponding media tag in the user's master playlist (S255). The user plays, streams and/or buffers media files on the user device 110 from the server 100 through the web browser or the local application (S265). Media files for which there is no media tag in the user's master playlist are not available to that user, i.e. they cannot be accessed, streamed or buffered by the user. The user may be given access to download any media file for which there is a corresponding media tag in the user's master playlist. The user can, therefore, access his/her entire collection of media files from any of the user devices 110 without having to transfer the media files to the respective devices. The redundancy checking between the files of multiple different users provided by example embodiments allows for each file to be uploaded, from multiple users, to the server 100 only once, and for the multiple users to be provided access to the file stored by the server 100 based on the tags in their main playlists without having to upload the file themselves.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for storing files of multiple users and for providing user access to the stored files comprising:
receiving at a server one or more tags corresponding to one or more files of a user, wherein the tags identify the files, and each of the tags is associated with the user;
storing each of the tags in a list associated with the user;
comparing each of the tags stored in the list associated with the user to a list of tags previously stored by the server, the list of tags previously stored by the server including tags associated with a plurality of different users and having corresponding previously stored files;
receiving at the server a file of the one or more files which corresponds to the tags in the list associated with the user if a corresponding tag of the file is not in the list of tags previously stored by the server;
storing the file by the server if the corresponding tag of the file is not in the list of tags previously stored by the server; and
providing the user access to each of the files stored by the server which correspond to the tags stored in the list associated with the user.

2. The method of claim 1, further comprising:
updating the list of tags previously stored by the server to include the corresponding tag of the file received at the server.

3. The method of claim 1, further comprising:
sanitizing the one or more tags received at the server to have the same format as the tags in the list of tags previously stored by the server.

4. The method of claim 1, comprising:
authenticating the user at the server before sending each of the tags to the server.

5. The method of claim 1, wherein the tags for the one or more files include an artist identifier and a title identifier for each of the files.

6. The method of claim 1, wherein the tags for the one or more files include a spectrogram for each of the files.

7. The method of claim 1, comprising:
sending to a user device one or more of the files stored by the server for which the user is provided access.

8. The method of claim 1, wherein the step of comparing each of the tags stored in the list associated with the user to the list of tags previously stored by the server comprises skipping to a next tag in the list without uploading a file corresponding to a previous tag if the previous tag is in the list of tags previously stored by the server.

9. The method of claim 1, wherein the server comprises a server application that accesses a user device through interaction with an applet in a web browser or through a local application.

10. The method of claim 9, wherein the tags corresponding to the one or more files include a local file path of the file on a user device, and the server verifies that the file exists on the user device based on the local file path stored as part of the corresponding tag.

11. A system, comprising:
a server configured to
receive one or more tags corresponding to one or more files of a user, each of the tags being based on information from the files and associated with the user,
store each of the tags in a list associated with the user,
compare each of the tags stored in the list associated with the user to a list of tags previously stored by the server, the list of tags previously stored by the server including tags associated with a plurality of different users and having corresponding files stored by the server,
receive a file of the one or more files which correspond to the tags in the list associated with the user if a corresponding tag of the file is not in the list of tags previously stored by the server,
store the file by the server if the corresponding tag of the file is not in the list of tags previously stored by the server, and
provide the user access to each of the files stored by the server which correspond to the tags stored in the list associated with the user.

12. A non-tangible computer readable medium storing a computer program which when executed by a computer performs a method comprising:
receiving at a server one or more tags corresponding to one or more files of a user, wherein the tags identify the files, and each of the tags is associated with the user;
storing each of the tags in a list associated with the user;
comparing each of the tags stored in the list associated with the user to a list of tags previously stored by the server, the list of tags previously stored by the server including tags associated with a plurality of different users and having corresponding previously stored files stored by the server;
receiving at the server a file of the one or more files which correspond to the tags in the list associated with the user if a corresponding tag of the file is not in the list of tags previously stored by the server;
storing the file by the server if the corresponding tag of the file is not in the list of tags previously stored by the server; and
providing the user access to each of the files stored by the server which correspond to the tags stored in the list associated with the user.
